(19) United States
(12) Patent Application Publication
(10) Pub. No.: US 2015/0074158 A1
(43) Pub. Date: Mar. 12, 2015

(54) METHOD AND SYSTEM FOR PRINCIPAL COMPONENT ANALYSIS

(71) Applicant: Technion Research & Development Foundation Limited, Haifa (IL)

(72) Inventors: Ron Kimmel, Haifa (IL); Yonathan Aflalo, Tel-Aviv (IL)

(21) Appl. No.: 14/480,747

(22) Filed: Sep. 9, 2014

Related U.S. Application Data
(60) Provisional application No. 61/875,423, filed on Sep. 9, 2013.

(51) Int. Cl. G06F 1/02; G06F 17/16

(52) U.S. Cl. CPC G06F 1/02; G06F 17/16
USPC 708/270

(57) ABSTRACT

A method of constructing a set of basis functions is disclosed. The method comprises: receiving a set of data vectors describing a physical object or a physical phenomenon; using a data processor for calculating a set of eigenvalues for an objective matrix defined as a sum of a first matrix corresponding to the set of data vectors and a second matrix corresponding to a Laplace-Beltrami operator, the objective matrix being a positive definite matrix; and constructing the set of basis functions based on at least a subset of the eigenvalues.

### RELATED APPLICATION

This application claims the benefit of priority under 35 USC 119(e) of U.S. Provisional Patent Application No. 61/875,423 filed Sep. 9, 2013, the contents of which are incorporated herein by reference in their entirety.

### FIELD AND BACKGROUND OF THE INVENTION

The present invention, in some embodiments thereof, relates to computerized data analysis and, more particularly, but not exclusively, to a method and system for principal component analysis.

Many engineering applications require classification or categorization of objects representing real world entities based on features of the entities. Examples of such applications include processing media objects representing audio, video or graphics data, categorizing documents, analyzing geographical data, rendering maps, analysis of medical images for diagnosis and treatment, analysis of biological and chemical data samples, and the like. Real world entities have spatial and/or temporal characteristics which are used for classifying the entities. These characteristics are themselves represented as features of data objects that likewise have spatial and/or temporal characteristics.

For example, a media object comprises data elements with spatial and/or temporal characteristics, in that the data elements have a spatial (distance between pixels within an individual image) and/or temporal extent (pixels values over time). Features derived from these characteristics are used for classification. For example, in image analysis, changes in pixel hue, saturation, or luminosity (either spatial within the image or temporal across images) are used to identify useful information about the image, whether to detect a person's face in a photograph, a tumor in a radiological scan, or the motion of an intruder in a surveillance video.

In signal processing of audio signals, changes in signal amplitude, frequency, phase, energy, and the like are used to classify signals and detect events of interest.

A known data analysis technique is principal component analysis (PCA), in which for data described by multi-dimensional vectors, a subset of dimensions is selected according to some criterion. PCA techniques are disclosed in U.S. Pat. Nos. 6,671,661, 7,096,153 and 8,041,539.

### SUMMARY OF THE INVENTION

According to an aspect of some embodiments of the present invention there is provided a method of constructing a set of basis functions. The method comprises: receiving a set of data vectors describing a physical object or a physical phenomenon; using a data processor for calculating a set of eigenvalues for an objective matrix defined as a sum of a first matrix corresponding to the set of data vectors and a second matrix corresponding to a Laplace-Beltrami operator, the objective matrix being a positive definite matrix; and constructing the set of basis functions based on at least a subset of the eigenvalues.

According to some embodiments of the invention the method wherein the calculating a set of eigenvalues is executed without storing the objective matrix.

According to an aspect of some embodiments of the present invention there is provided a method of constructing a set of basis functions. The method comprises: receiving a set of data vectors describing a physical object or a physical phenomenon; using a data processor for calculating a set of eigenvalues for an objective matrix defined as a sum of a first matrix corresponding to the set of data vectors and a second matrix corresponding to a Laplace-Beltrami operator, the set of eigenvalues being calculated without storing the objective matrix; and constructing the set of basis functions based on at least a subset of the eigenvalues.

According to some embodiments of the invention the calculation of set of eigenvalues comprises executing an iterative procedure, which calculates, at each of at least some iterations, a processed vector without calculating the positive matrix, the processed vector being a multiplication of the positive matrix by one of the data vectors.

According to some embodiments of the invention the processed vector is calculated by applying to the data vector, separately, a first processing procedure corresponding the first matrix, and a second processing procedure corresponding the second matrix.

According to some embodiments of the invention the second processing procedure comprises solving a vector equation so as to find a vector that, when multiplied by a weight matrix, provides the data vector.

According to some embodiments of the invention the data vectors describe coordinates of a physical surface or a computer generated surface.

According to some embodiments of the invention the data vectors describe an image.

According to some embodiments of the invention the data vectors describe a signal.

According to some embodiments of the invention the data vectors describe a temperature distribution.

According to some embodiments of the invention the data vectors describe a light intensity distribution.

According to some embodiments of the invention the data vectors describe spectral distribution.

According to some embodiments of the invention the data vectors describe a probability distribution.

According to some embodiments of the invention the data vectors describe biological data.

According to some embodiments of the invention the data vectors describe chemical data.

According to some embodiments of the invention the data vectors describe machine vision data.

According to an aspect of some embodiments of the present invention there is provided a computer software product, comprising a non-volatile computer-readable medium in which program instructions are stored, which instructions, when read by a data processor, cause the data processor to execute the method as described above and optionally as exemplified below.

According to an aspect of some embodiments of the present invention there is provided a system for constructing a set of basis functions, comprising a data processor configured for receiving a set of data vectors describing a physical object or a physical phenomenon, for calculating a set of eigenvalues for an objective matrix defined as a sum of a first matrix corresponding to the set of data vectors and a second matrix corresponding to a Laplace-Beltrami operator, the objective matrix being a positive definite matrix; and for constructing the set of basis functions based on at least a subset of the eigenvalues.

According to some embodiments of the invention the calculating the set of eigenvalues is executed without storing the objective matrix.

According to an aspect of some embodiments of the present invention there is provided a system for constructing a set of basis functions, comprising a data processor configured for receiving a set of data vectors describing a physical object or a physical phenomenon, for calculating a set of eigenvalues for an objective matrix defined as a sum of a first matrix corresponding to the set of data vectors and a second matrix corresponding to a Laplace-Beltrami operator, the set of eigenvalues being calculated without storing the objective matrix; and for constructing the set of basis functions based on at least a subset of the eigenvalues.

According to some embodiments of the invention a sparsity of the second matrix is larger than a sparsity of the first matrix.

According to some embodiments of the invention the second matrix is a pseudo-inverse matrix of a weight matrix.

According to some embodiments of the invention the weight matrix is a cotangent weight matrix.

According to some embodiments of the invention the data processor is configured for calculating a set of eigenvalues by executing an iterative procedure, which calculates, at each of at least some iterations, a processed vector without calculating the positive matrix, the processed vector being a multiplication of the positive matrix by one of the data vectors.

According to some embodiments of the invention the data processor is configured for calculating the processed vector by applying to the data vector, separately, a first processing procedure corresponding the first matrix, and a second processing procedure corresponding the second matrix.

According to some embodiments of the invention the first processing procedure comprises multiplying the data vector by the first matrix.

According to some embodiments of the invention the second processing procedure comprises solving a vector equation so as to find a vector that, when multiplied by a weight matrix, provides the data vector.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method constructing a set of basis functions according to various exemplary embodiments of the present invention;

FIG. 2 shows angles defined on a triangle mesh;

FIG. 3 shows the representation error as a function of the signal to noise ratio (SNR), as obtained in an experiment performed according to some embodiments of the present invention;

FIGS. 4A and 4B show two poses used as data vectors in an experiment performed according to some embodiments of the present invention;

FIGS. 5A-5E show five poses at which a reconstruction procedure performed according to some embodiments of the present invention was targeted;

FIGS. 6A-6E show projections of the coordinates of the poses of FIGS. 5A-E to the first leading 100 vectors of the Laplace Beltrami eigen-basis;

FIGS. 7A-7E show the results of the reconstructions of the poses of FIGS. 5A-E using a conventional PCA;

FIGS. 8A-E show the results of the reconstructions of the poses of FIGS. 5A-E according to some embodiments of the present invention;

FIGS. 9A and 9B show two out of 100 postures that were used as data vectors in another experiment performed according to some embodiments of the present invention;

FIG. 10 shows a posture at which a reconstruction procedure performed according to some embodiments of the present invention was targeted;

FIG. 11 shows the result of LBO reconstruction of the posture of FIG. 10;

FIG. 12 shows the results of a reconstruction of the posture of FIG. 10 using conventional PCA;

FIG. 13 shows the results of a reconstruction of the posture of FIG. 10 according to some embodiments of the present invention; and

FIG. 14 shows functional map geodesic projection errors calculated for an LBO basis and for a basis constructed according to some embodiments of the present invention.

### DESCRIPTION OF SPECIFIC EMBODIMENTS OF THE INVENTION

The present invention, in some embodiments thereof, relates to computerized data analysis and, more particularly, but not exclusively, to a method and system for principal component analysis.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Some embodiments of the present invention construct a set of basis functions. The set of basis functions are typically constructed from a set of multidimensional data vectors, wherein the basis functions span a space whose dimensionality is smaller than the dimensionality of the data vectors. Thus, the present embodiments apply a PCA to the multidimensional data.

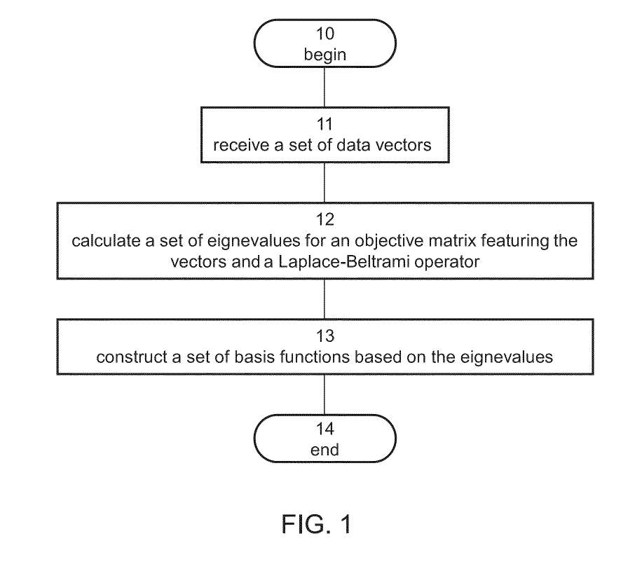

FIG. 1 is a flowchart diagram of a method constructing a set of basis functions according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method can be embodied in many forms. For example, it can be embodied in on a tangible medium such as a computer for performing the method steps. It can be embodied on a computer readable medium, preferably a non-volatile computer readable medium, comprising computer readable instructions for carrying out the method steps. In can also be embodied in electronic device having digital computer capabilities arranged to run the computer program on the tangible medium or execute the instruction on a computer readable medium.

Computer programs implementing the method of the present embodiments can commonly be distributed to users over a communication network, such as the internet, or on a distribution medium such as, but not limited to, a CD-ROM or a flash drive. From the communication network or distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of the present embodiments. All these operations are well-known to those skilled in the art of computer systems.

The method begins at 10 and continues to 11 at which a set of data vectors is received. The data vectors describe a physical object or a physical phenomenon. For example, the data vectors can describe coordinates of a surface, which can be a physical surface or a computer generated surface. The data vectors can describe coordinates at various poses of an articulated object in three dimensions. The data vectors can also describe an image, e.g., a video image. The data vectors can also describe a signal, such as an audio signal or an electromagnetic signal. The data vectors can describe one or more distributions including, without limitation, a temperature distribution, a light intensity distribution, a spectral distribution and a probability distribution. The data vectors can also describe biological data, e.g., protein expression data, and/or genomic data. The data vectors can also describe chemical data, such as chemical structures and/or chemical properties. The data vectors can also describe machine vision data, such as patterns identifiable by a computer.

The method continues to 12 at which a set of eigenvalues for an objective matrix M3 is calculated.

Herein, reference signs to the drawings are represented by bold numbers, matrices are represented by bold upper-case letters or bold combinations of upper-case letters and numbers, and vectors are represented by underlined lower-case letters or combinations of lower-case letters and numbers.

The objective matrix M3 features the data vectors and defined as a sum of a first matrix corresponding to set of data vectors and a Laplace-Beltrami Operator (LBO). The LBO is defined over a non-planar surface, and is generally defined as the divergence of the gradient of the surface.

Formally, a non-planar surface is a metric space induced by a smooth connected and compact Riemannian 2-manifold. Ideally, the geometric properties of the non-planar surface would be provided explicitly for example, the slope and curvature (or even other spatial derivatives or combinations thereof) for every point of the non-planar surface. Yet, such information is rarely attainable and a discretized version of the non-planar surface, which is a set of points on the Riemannian 2-manifold and which is sufficient for describing the topology of the 2-manifold, is used. The metric tensor of non-planar surface is denoted by the upper case letter G. G defines distances on the non-planar surface, scalar products between vectors or vector fields that are tangential to the non-planar surface, and scalar products between functions that are defined on the non-planar surface. The determinant of the metric tensor G is denoted by the lower-case letter g, and the discretization matrix of the square root of g is denoted A. For example, when the non-planar surface is triangulated, A can be a diagonal matrix whose Aᵢᵢ element is the sum of areas of all triangles that share the surface vertex i.

In some embodiments of the present invention the LBO is based on information provided separately from the data vectors, and in some embodiments of the present invention the LBO is calculated based on the data vectors without receiving additional input regarding the non-planar surface. In the latter case, geometric information about the surface is extracted from the data vectors.

In some embodiments of the present invention the objective matrix M3 is defined as a sum of a first matrix M1, corresponding to the data vectors, and a second matrix M2, corresponding to the LBO. In some embodiments of the present invention the sparsity of second matrix M2 is larger than the sparsity of first matrix M1. The objective matrix M3 is optionally and preferably a positive definite matrix. In these embodiments, M3 satisfies the relation x^{T} M3 x>0 for any vector x. The advantage of these embodiments is that they reduce the complexity of the numerical calculation of the eigenvalues.

The eigenvalues of M3 are optionally and preferably calculated without storing the objective matrix M3. The advantage of these embodiments is that the objective matrix M3 may be significantly large and storing it may require a significant amount of computer resources. In some embodiments of the present invention M3 is not stored at all during the entire execution of the method.

In a most preferred embodiment, the objective matrix M3 is a positive definite matrix and is not stored during the calculation of eigenvalues (more preferably not stored at all). This embodiment can be employed together with any embodiment described herein.

The first matrix M1 can comprise the combination XX^{T}, where X is a matrix whose columns are the data vectors received at 11, and the superscript T denotes a transpose operation. The numbers of rows and columns in the matrix X is denoted by m and n, respectively. Typically, the first matrix M1 is expressed in the context of the metric tensor G of the non-planar surface. For example, in some embodiments of the present invention embodiments M1=AXX^{T}A. Alternatively, a factorization procedure, such as, but not limited to, a singular value decomposition (SVD), can be applied to the matrix X.

In a representative example of this embodiment, an SVD factorization is applied to X so as to express X as UDV^{T}, where U and V are orthonormal matrices, and D is a diagonal matrix. In these embodiments, M1 can be expressed as Ũ D² Ũ^{T}, where Ũ is a matrix defined as AU. In some embodiments of the present invention the size of U is n×m the size of D is m×m and the size of V is m×m. Alternatively, the size of U can be m×m the size of D can be m×n and the size of V can be n×n.

The second matrix M2 can be a pseudo-inverse matrix \tilde{W}⁻¹ of a weight matrix W.

As used herein, a matrix \tilde{W}⁻¹ is referred to as a pseudo-inverse of a matrix W if it obeys the following conditions: (i) W \tilde{W}⁻¹ W=W, (ii) \tilde{W}⁻¹ W \tilde{W}⁻¹=\tilde{W}⁻¹, (iii) (W \tilde{W}⁻¹)^{T}=W \tilde{W}⁻¹, and (iv) (\tilde{W}⁻¹ W)^{T}=\tilde{W}⁻¹ W.

Preferably, the weight matrix W is defined in terms of cotangent edge weights which are suitable for constructing a discrete LBO operator on a triangle mesh that discretized the non-planar surface. Cotangent edge weights are weights that are assigned to the edges of the triangles of the meshes, and that are proportional to cotangents of angles between edges. The use of the cotangent function is particularly useful since it expresses the ratio between a scalar product and a vector product between two edges. Typically, an edge is assigned with a weight that is proportional to cotangents of angles between edges that share triangles with it. When an edge is on the boundary of the surface, it is associated with one angle and it can be assigned with a weight that is proportional to the cotangent of the angle against the edge at a vertex of the triangle opposite to the edge. When an edge is internal with respect to the boundary of the surface, it is associated with two triangles and it can be assigned with a weight that is proportional to the sum of cotangents of the angles against the edge at the vertices of the two triangles opposite to the edge.

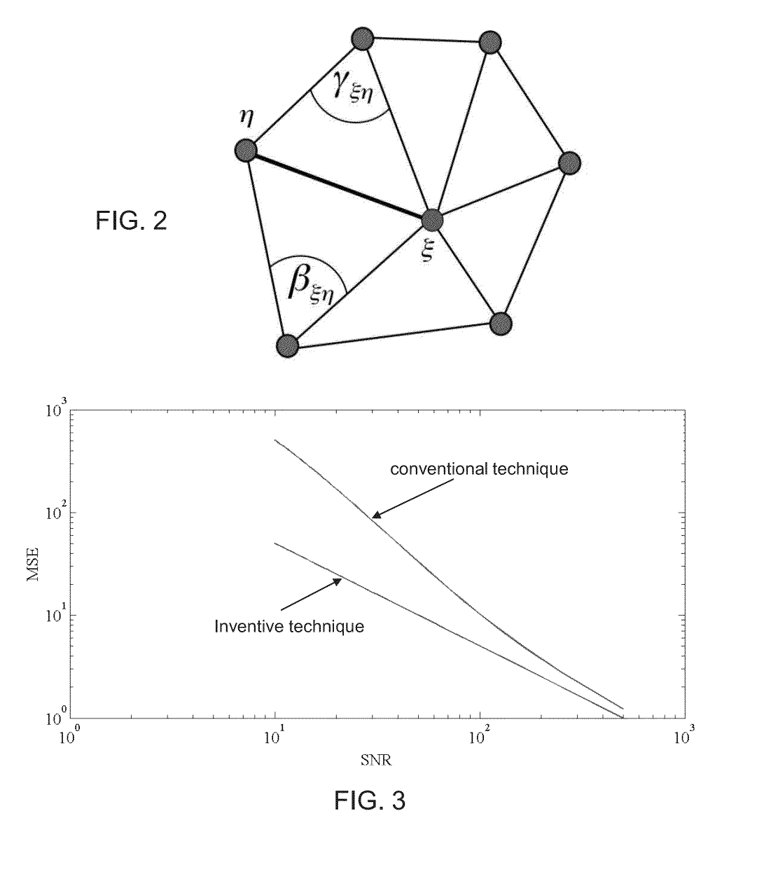

A portion of a triangle mesh is illustrated in FIG. 2. An edge (ξ, η) is marked between two vertices ξ and η. The edge is illustrated as internal and is therefore shared by two triangles. In each triangle, there is a vertex that is opposite to edge (ξ, η). The angles against (ξ, η) at the two vertices opposite to (ξ, η) are denoted β_{ξη} and γ_{ξη}. Using these notations, the weight matrix W can be defined as:

$${W}_{ξ η} = \{ \begin{matrix}{\sum }_{{τ}_{( ξ , τ ) ∈ E}}^{ } ( cot {γ}_{ ξ τ} + cot {β}_{ ξ τ} ) & if ξ = η \\ - ( cot {γ}_{ ξ η} + cot {β}_{ξ η} ) & if ξ \neq η , ( ξ , η ) ∈ E\end{matrix} \qquad EQ . 1$$

where E is the set of edges of the triangle mesh.

Other discretization of the LBO, such as, but not limited to, via the Finite Elements Method, are also contemplated.

The calculation of the eigenvalues of the objective matrix M3 optionally and preferably comprises executing an iterative procedure. At each of at least some of the iterations, the procedure calculates a processed vector v without calculating the objective matrix M3, wherein the processed vector v is a multiplication of matrix M3 by one of the data vectors. In a single iteration in the iterative procedure, a data vector x can be processed by applying, separately, a first processing procedure corresponding top the matrix M1, and first processing procedure corresponding top the matrix M2, and the results of these processing procedures can be added to provide the processed vector v.

For example, when M1=Ũ D² Ũ^{T}, the first processing procedure can include multiplying x by Ũ^{T}, multiplying the result of this multiplication by D², and multiplying the result of the latter multiplication by Ũ. This provides a first contribution to the processed vector v. When M2=\tilde{W}⁻¹, the second processing procedure can include numerically solving the equation x=Wu for u and defining u as a second contribution to the processed vector v. The first and second contributions to v can then be added to provide the vector v.

In the above exemplified technique for calculating the processed vector v, the matrix M3 is not calculated or stored, thereby reducing the computational resources that are required. The processed vector v can be used during the iterative procedure for the calculation of the eigenvalues of the objective matrix, wherein the iterative procedure receives v at each iteration and does not calculates or store M3. The iterative procedure optionally and preferably employs the Arnoldi algorithm. Given a square matrix and a vector a sequence of vectors called a Krylov space is obtained. The Arnoldi algorithm is a kind of Krylov subspace method, and can be employed to generate an orthonormal matrix that spans the same subspace as the Krylov subspace.

Other eigenvalue algorithms suitable for the present embodiments including, without limitation, Rayleigh quotient inverse iteration, Lanczos algorithm, and Jacobi eigenvalue algorithm.

Once the eigenvalues are calculated, the method proceeds to 13 at which a set of basis functions is constructed based on at least a subset of the eigenvalues. This is optionally and preferably done by selecting a subset which includes the largest eigenvalues obtained at 12, as known in the art of PCA. For each eigenvalue of the selected subset, a corresponding eigenvector is obtained, for example, by finding non-zero solutions of the respective eigenvalue equation, as known in the art. Each of the eigenvectors can be defined as a discretization of one basis function.

The method ends at 14.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### Example

Reference is now made to the following example, which together with the above descriptions illustrate some embodiments of the invention in a non limiting fashion.

The present example demonstrates that the Laplace-Beltrami Operator decomposition can be used to provides a basis of smooth function representation on a manifold. The LBO is combined with PCA, to provide an eigenvalue problem that balances between surface representation in the embedding space and smooth functions defined on the surface itself.

The following notations are used in the present example.

In the present example, the quantities xᵢ and Pⱼ represent vectors even when not underlined.

A two dimensional parameterized Riemannian manifold M, is considered. The metric tensor of the manifold is denoted G. The following several scalar products [symbol] .,. [symbol] _{G} are defined.

For any tangent plane of M at any point xεM, denoted by Tₓ(M), given two vectors (u, v)εTₓ(M), the scalar product [symbol] u,v [symbol] _{G} is defined as:

[symbol]

u,v [symbol] _{G}=u^{T}Gv.

For any pair of functions (ƒ, h) defined on M, the scalar product [symbol] ƒ,h [symbol] _{G} is defined as:

[symbol]

ƒ,h [symbol] _{G}=∫∫_{p(M)}ƒ(x)h(x)\sqrt{g}gdx,

where p(M) represents the parameterization space of M, and g=det(G).

For any pair of vector fields (U, V) defined on T(M), the scalar product [symbol] U,V [symbol] _{G} is defined as:

[symbol]

U,V [symbol] _{G}=∫∫_{p(M)}U(x)^{T}GV(x)\sqrt{g}gdx.

For each of the above scalar products, the respective norm is defined as

∥·∥_{G}=\sqrt{ [symbol].,. [symbol] _{G}}.

The metric tensor G also defines the following differential geometric operations for any function ƒ that is defined over p(M):

$${∇}_{G} f = {G}^{- 1} {∇}_{x} f = \sqrt{g} {\sum }_{j}^{ } {g}^{ij} {\partial }_{j} f ,$$

where g^{ij}=(G⁻¹)ᵢⱼ and ∂ᵢ is the derivative with respect to the xᵢ coordinate; and

$${∇}_{G} f = \frac{1}{\sqrt{g}} {\sum }_{i}^{ } {\partial }_{i} ( {∇}_{G} f ) = \frac{1}{\sqrt{g}} {\sum }_{i}^{ } {\partial }_{i} ( \sqrt{g} {\sum }_{j}^{ } {g}^{ij} {\partial }_{j} f ) .$$

In the present example, the problem of finding the smoothest functional orthonormal basis on M is considered.

As used herein the term “smooth,” in the context of a function ƒ, refers to a function having a gradient ∇_{G}ƒ whose L₂ norm ∥∇_{G}ƒ∥² is below a predetermined threshold.

As an example, for a smoothest functional orthonormal basis, it is desired to find a finite basis of, say, n functions {φⁱ}, i=1, . . . , n, that approximate any given smooth function. Formally, for any given function ƒ on the manifold, such that ∥∇_{G}ƒ∥²<c, the desired set of basis functions {φᵢ} allow to approximate f≈Σ [symbol] f,φᵢ [symbol] φᵢ, such that the representation error, defined by

$${r}_{n} = f - {\sum }_{1}^{n} 〈 f , {φ}_{i} 〉 {φ}_{i} , \qquad EQ . A .1$$

converges rapidly to zero in, say, O(1/n). Any smooth function with bounded gradient could be represented as a linear combination of functions with bounded gradients. In the present example, a basis whose Dirichlet energy is sufficiently small (e.g., minimal), is searched for.

The smoothest basis can be defined as:

$${arg min }_{{\{ {φ}_{i} \}}_{i = 1}^{n}} {\sum }_{i = 1}^{n} {‖ {∇}_{G} {φ}_{i} ‖}_{G}^{2} \\ s . t . {〈 {φ}_{i} , {φ}_{j} 〉}_{G} = {δ}_{ij} ∀ ( i , j ) , \qquad EQ . A .2$$

where δᵢⱼ is the Kronecker delta symbol, and n is the number of desired basis functions.

The spectral theorem applied to the operator Δ_{G} implies that it admits a spectral decomposition, that is, an orthogonal eigenbasis {ψᵢ} and a set of corresponding eigenvalues {λᵢ≧0}, where i is a natural number and:

Δ_{G}ψᵢ=λᵢψᵢ, [symbol] ψᵢ,ψⱼ [symbol] _{G}=δ_{i,j},

For each pair (i, j) of natural numbers.

Without loss of generality, it is assumed that the λᵢ's are ordered in an increasing order. Then, any function φᵢ can be expressed as:

$${φ}_{i} = {\sum }_{j}^{ } {〈 {φ}_{i} , {φ}_{j} 〉}_{G} {ψ}_{j} = {\sum }_{j}^{ } {α}_{j}^{i} {ψ}_{j} .$$

Since norm of the gradient of the ith basis function φᵢ satisfies the following relations:

∥∇_{G}φᵢ∥_{G}²= [symbol] ∇_{G}φᵢ,φᵢ [symbol] _{G}

One obtains:

$$\begin{matrix} {‖ {∇}_{G} {φ}_{i} ‖}_{G}^{2} = {〈 {Δ}_{G} ( {\sum }_{j}^{ } {α}_{j}^{i} {ψ}_{j} ) , {\sum }_{j}^{ } {α}_{j}^{i} {ψ}_{j} 〉}_{\\ G} \\ = {〈 {\sum }_{j}^{ } {λ}_{j} {α}_{j}^{i} {ψ}_{j} , {\sum }_{j}^{ } {α}_{j}^{i} {ψ}_{j} 〉}_{G} \\ = {\sum }_{j}^{ } {\sum }_{k}^{ } {λ}_{j} {α}_{j}^{i} {{α}_{k}^{i} ( {ψ}_{k} , {ψ}_{j} )}_{G} \\ = {\sum }_{j}^{ } {{λ}_{j} ( {α}_{j}^{i} )}^{2} .\end{matrix}$$

According to the definition of the scalar product:

$$\begin{matrix}{〈 {φ}_{i} , {φ}_{j} 〉}_{G} = {〈 {\sum }_{k}^{ } {α}_{k}^{i} {ψ}_{k} , {\sum }_{l}^{ } {α}_{l}^{j} {ψ}_{l} 〉}_{G} \\ = {\sum }_{k}^{ } {\sum }_{l}^{ } {α}_{k}^{i} {α}_{l}^{i} {〈 {ψ}_{k} , {ψ}_{l} 〉}_{G} \\ = {\sum }_{k}^{ } {α}_{k}^{i} {α}_{k}^{j} .\end{matrix}$$

The problem defined in EQ. A.2 can be written as:

$${min}_{α} {\sum }_{i = 1}^{n} {\sum }_{j = 1}^{∞} {{λ}_{j} ( {α}_{j}^{i} )}^{2}$$

$$s . t . {\sum }_{k}^{ } {α}_{k}^{i} {α}_{k}^{j} = {δ}_{ij} .$$

These relations can be written using matrix convention, as follows:

$${min}_{α} trace ( α diag ( λ ) {α}^{T} )$$

$$s . t . \\ {αα}^{T} = {I}_{n} ,$$

where α is an infinite matrix α_{i,j}=αⱼⁱ, Iₙ represents the (n×n) identity matrix, and diag(λ) is a diagonal matrix such that diag(λ)_{i,i}=λᵢ.

The solution of this problem is realized for

$${α}_{i , j} = \{ \begin{matrix}{δ}_{ij} & for i , j \leq n \\ 0 & otherwise\end{matrix} .$$

As will be shown below, the basis constructed by the first n eigenfunctions of the LBO is proper for representing smooth functions defined on the manifold. It can thus serve as an efficient representation for such functions.

In order to prove the efficiency of LBO eigenfunctions in representing smooth functions, consider a smooth function ƒ with bounded gradient ∥∇_{G}ƒ∥_{G}.

The representation residual function is:

$${r}_{n} = f - {\sum }_{i = 1}^{n} 〈 f , {ψ}_{i} 〉 G {ψ}_{i} .$$

The present inventors found that for each i satisfying 1≦i≦n: each of the scalar products [symbol] rₙ, ψ [symbol] _{G} and [symbol] ∇_{G}rₙ, ∇_{G}ψᵢ [symbol] _{G} equals zero. Using these properties, the norms of rₙ and its gradient are obtained:

$${‖ {r}_{n} ‖}_{G}^{2} = {‖ {\sum }_{i = n + 1}^{∞} 〈 {r}_{n} , {ψ}_{i} 〉 G {ψ}_{i} ‖}_{G}^{2} = {\sum }_{i = n + 1}^{∞} {〈 {r}_{n} , {ψ}_{i} 〉}_{G}^{2}$$

$${‖ {∇}_{G} {r}_{n} ‖}_{G}^{2} = {‖ {\sum }_{i = n + 1}^{∞} {〈 {r}_{n} , {ψ}_{i} 〉}_{G} {∇}_{G} {ψ}_{i} ‖}_{G}^{2} = {\sum }_{i = n + 1}^{∞} {〈 {r}_{n} , {ψ}_{i} 〉}_{G}^{2} {λ}_{i} \geq {λ}_{n + 1} {\sum }_{i = n + 1}^{∞} {〈 {r}_{n} , {ψ}_{i} 〉}_{G}^{2} .$$

The ratio between these norms satisfies:

$$\frac{{‖ {∇}_{G} {r}_{n} ‖}_{G}^{2}}{{‖ {r}_{n} ‖}_{G}^{2}} \geq {λ}_{n + 1} .$$

Since [symbol] ∇_{G}rₙ, ∇_{G}ψᵢ [symbol] _{G}=0, the norm of the gradient of f can be written as:

$${‖ {∇}_{G} f ‖}_{G}^{2} = {‖ {∇}_{G} {r}_{n} + {\sum }_{i = 1}^{n} {〈 f , {ψ}_{i} 〉}_{G} {∇}_{G} {ψ}_{i} ‖}_{G}^{2} = {‖ {∇}_{G} {r}_{n} ‖}_{G}^{2} + {\sum }_{i = 1}^{n} {〈 f , {ψ}_{i} 〉}_{G}^{2} {λ}_{i}$$

So that the norm of the residual function rₙ satisfies:

$${‖ {r}_{n} ‖}_{G}^{2} \leq \frac{{‖ {∇}_{G} {r}_{n} ‖}_{G}^{2}}{{λ}_{n + 1}} \leq \frac{{‖ {∇}_{G} f ‖}_{G}^{2}}{{λ}_{n + 1}}$$

For two dimensional manifolds the spectra has a linear behavior in n, that is λₙ≈Cn as n→∞, where C is a constant number. The residual function rₙ depends linearly on ∥∇_{G}∫∥ which is bounded by a constant. It follows that rₙ converges asymptotically to zero at a rate of O(1/n) when setting {φᵢ} to be {ψᵢ}.

Thus, it has been shown that the leading subset of eigenfunctions of the LBO, ordered by the magnitude of their corresponding eigenvalues, provides a proper basis for representing smooth functions on the manifold. This observation by the present inventors allows designing a basis that would efficiently represent a set of given functions on the manifold.

The procedure of PCA will now be explained.

In PCA, a given set of functions is represented by a linear combination of a small set of basis functions. As an example, given a set of k vectors xᵢ in n dimensions, the PCA algorithm finds an orthonormal basis of m≦k vectors Pⱼ by solving the following problem:

$${min}_{P} {\sum }_{i = 1}^{k} {‖ {PP}^{T} {x}_{i} - {x}_{i} ‖}_{2}^{2} \\ s . t . \\ {P}^{T} P = {I}_{m} . \qquad EQ . A .3$$

The quantity PP^{T}xᵢ is the projection of the vector xᵢ onto the orthonormal basis P. Thus, the term in the summation of EQ. A.3 represents the error of projecting xᵢ onto P, and can be written as:

$$\begin{matrix}{‖ {PP}^{T} {x}_{i} - {x}_{i} ‖}_{2}^{2} = {( {PP}^{T} {x}_{i} - {x}_{i} )}^{T} ( {PP}^{T} {x}_{i} - {x}_{i} ) \\ = {x}_{i}^{T} P \underbrace{{P}^{T} P}_{= {I}_{m}} {P}^{T} {x}_{i} - 2 {x}_{i}^{T} P {P}^{T} {x}_{i} + {x}_{i}^{T} {x}_{i} \\ = {x}_{i}^{T} {x}_{i} - {x}_{i}^{T} {PP}^{T} {x}_{i} \\ = {x}_{i}^{T} {x}_{i} - trace ( {x}_{i}^{T} {PP}^{T} {x}_{i} ) \\ = {x}_{i}^{T} {x}_{i} - trace ( {PP}^{T} {x}_{i} {x}_{i}^{T} ) .\end{matrix}$$

The minimization problem is therefore equivalent to:

$${max}_{P} {\sum }_{i = 1}^{m} trace ( {PP}^{T} {x}_{i} {x}_{i}^{T} ) \\ s . t . \\ {P}^{T} P = {I}_{m} . \\ Since \\ {\sum }_{i = 1}^{m} {x}_{i} {x}_{i}^{T} = {XX}^{T} , \qquad EQ . A .4$$

where X is a matrix whose columns account for the xᵢ's, the problem defined in EQ. A.4 can be written as

$${max}_{P} trace ( {PP}^{T} {XX}^{T} )$$

$$s . t . \\ {P}^{T} P = {I}_{m} .$$

The solution of this problem can be obtained by a singular value decomposition of the matrix X.

The present inventors successfully devised a technique that find an orthonormal basis for a functional space defined on M that reduces the projection error of the vectors x₁, . . . , xₙ, while requiring the basis to be smooth, where x₁, . . . , xₙ, is set of n vectors representing the discretization of a set of given functions on M.

The mathematical problem can be formally written as:

$${min}_{P} {\sum }_{i = 1}^{m} {‖ {PP}^{T} {Ax}_{i} - {x}_{i} ‖}_{G}^{2} + μ {\sum }_{j = 1}^{m} {‖ {∇}_{G} {P}_{j} ‖}_{G}^{2} s . t . {P}^{T} AP = {I}_{m}$$

where A is a discretization matrix of the square root of the determinant of the metric tensor G. ∇_{G}Pⱼ is a discretization of the gradient of the vector Pⱼ (representing the discretization of the respective function). For a triangulated surface, A is given by a diagonal matrix whose Aᵢᵢ element is the sum of areas of all triangles that share the surface vertex i. The norm if ∇_{G}Pⱼ satisfies the relation

∥∇_{G}Pⱼ∥_{G}²=(LPⱼ)^{T}APⱼ,

where L is a discretization matrix of the LBO. As an example for L, the cotangent weight discretization can be used [U. Pinkall and K Polthier, Computing discrete minimal surfaces and their conjugates. Experimental mathematics, 2(1):15-36, 1993].

A weight matrix can define the discrete LBO as

L=A₋₁W

An exemplary cotangent weight matrix can is provided above.

The term (LPj)^{T}APⱼ can be written as

(LPⱼ)^{T}APⱼ=Pⱼ^{T}W^{T}A^{-T}APⱼ=Pⱼ^{T}WPⱼ=trace(WPⱼPⱼ^{T})

Using these notations, the formulation of the discrete regularized PCA can be approximated by:

$${min}_{P} trace ( - {PP}^{T} {AXX}^{T} A ) + μ trace ( {PP}^{T} W ) \\ s . t . \\ {P}^{T} AP = {I}_{m} , \qquad EQ . A .5$$

where X is a n×m matrix whose columns are xᵢ, and μ is a predetermined regularity parameter. A typical value for μ is from about 0.1 to about 0.9. In experiments performed by the present inventor μ was selected to be 0.5. EQ. A.5 is equivalent to

$${min}_{P} trace ( {PP}^{T} ( μ W - {AXX}^{T} A ) ) \\ s . t . \\ {P}^{T} AP = {I}_{m} , \qquad EQ . A .6$$

Solving the problem defined in EQ. A.6 is equivalent to finding the eigenvectors of the matrix μW−AXX^{T}A that correspond to the largest algebraic eigenvalues. Classical algorithms performing eigendecomposition of a given matrix can provide eigenvectors sorted by the magnitudes of the eigenvalues, that correspond to the absolute values of the algebraic values. Several numerical optimization libraries such as ARPACK, LAPACK, EIGS implement the Arnoldi iterations algorithm to extract the eigenvector associated with the eigenvalue of largest magnitude. These methods are particularly efficient when the input is a sparse matrix.

Problem EQ. A.6 involves two matrices, the low rank AXX^{T}A, and the sparse W. The matrix AXX^{T}A is low rank in the sense that it can be generated or approximated by a small amount of some of its columns. The matrix W has a full rank, but it is sparse.

It was found by the present inventors that decomposition of the combination of the two using traditional solvers has two limitations.

A first limitation is that the given matrix has a size of n×n, where n is the number of vertices of the mesh. That number can be large when the mesh contains thousands of vertices. Storing the matrix explicitly can be difficult and the computation of the eigenvectors would require large computation resources.

A second limitation is that the combination of the two matrices is not guaranteed to be positive definite, so that the largest algebraic eigenvalue would not have to correspond to the eigenvalue with the largest magnitude.

The present inventors successfully resolved these issues, by devising a technique in which the eigenvalues of a matrix M are calculated using a function whose input is a vector x and its output is the product Mx, without storing the matrix M explicitly, and in which instead of finding the eigenvectors of the matrix itself, the eigenvectors of the inverse or pseudo inverse of the matrix are found.

Thus, solving the problem

$${min}_{P} trace ( {PP}^{T} W )$$

$$s . t . \\ {P}^{T} AP = {I}_{m} ,$$

is equivalent to solving the problem

$${min}_{P} trace ( {PP}^{T} {\tilde{W}}^{- 1} )$$

$$s . t . \\ {P}^{T} AP = {I}_{m} ,$$

where, \tilde{W}⁻¹ represents the pseudo inverse matrix of W. Thus, according to various exemplary embodiments of the present invention the following problem is solved:

$${min}_{P} trace ( {PP}^{T} ( {AXX}^{T} A + μ {\tilde{W}}^{- 1} ) ) \\ s . t . \\ {P}^{T} AP = {I}_{m} , \qquad EQ . A .7$$

In EQ. A.7, the matrix AXX^{T}A+μ\tilde{W}⁻¹ is symmetric and positive definite. Performing an economy size SVD of the matrix X such that X=UDV^{T} where U is an n×m orthonormal matrix, D is an m×m diagonal matrix, and V is an m×m orthonormal matrix, the following relation is obtained:

AXX^{T}A=AUD²U^{T}A=ŨD²Ũ^{T}

where, Ũ=AU.
The following procedure can be used for computing a function F(x) that receives a vector x and returns Ũ (D²(Ũ^{T}x))+μ\tilde{W}⁻¹x:

Require: x
v←Ũ^{T}x
v←D²v
v←Ũv
Find u solving x=Wu in a least square sense
v←v+u
Return v

It was found by the inventors that this computation of F(x) is efficient. First, Ũ^{T}x is calculated, where Ũ is an n×m matrix (m is equal to the number of the input functions, m<<n), that yields an m×1 vector. This operation has a complexity of O(mn). Then, the result is multiplied by D² which is an m×m matrix, an operation that takes O(m²). The result is multiplied by Ũ in O(mn). The overall computational complexity is O(mn) and the same holds for space complexity. The second phase consists of solving a sparse system, which can be efficiently executed with known algorithms, such as, but not limited to, the EIGS function in MATLAB®. The technique was found to efficiently converge, and provided hundred eigenvectors in less than a minute on a triangulated surface with 10,000 vertices.

### Experiments

In a first experiment, a set of smooth functions defined on a smooth manifold was used. This set is composed of several Heat Kernel Signatures (HKS) evaluated at various times [Sun et al., A concise and provably informative multi-scale signature based on heat diffusion. In Proceedings of the Symposium on Geometry Processing, SGP '09, pages 1383-1392, Aire-la-Ville, Switzerland, 2009. Eurographics Association. The time refers to intrinsic scale at which the signature is computed, while the signature itself can be viewed as a smoothed version of a Gaussian curvature. Noise was added to these HKS. The HKS, once supplemented by noise, were considered as the data vectors. Two sets of basis functions were constructed using the data vector. A conventional PCA basis, and a set of basis functions constructed by calculating eigenvalues for an objective matrix M3 defined as AXX^{T}A+μ\tilde{W}⁻¹, (in the present example, μ was taken to be 0.5). Next, other smooth functions that belong to the same family were selected. These smooth functions were signatures taken at a new time scale. The representation error was computed using both sets basis functions.

FIG. 3 shows the representation error as a function of the signal to noise ratio (SNR). Notice the significant advantage of using the inventive technique compared to the conventional PCA.

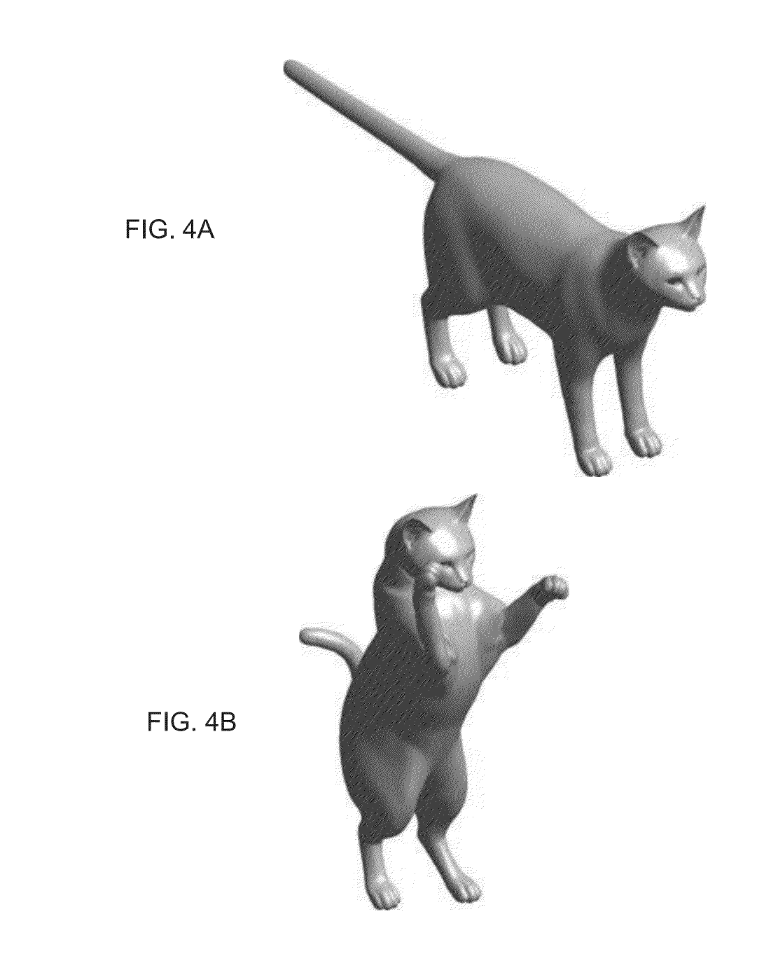

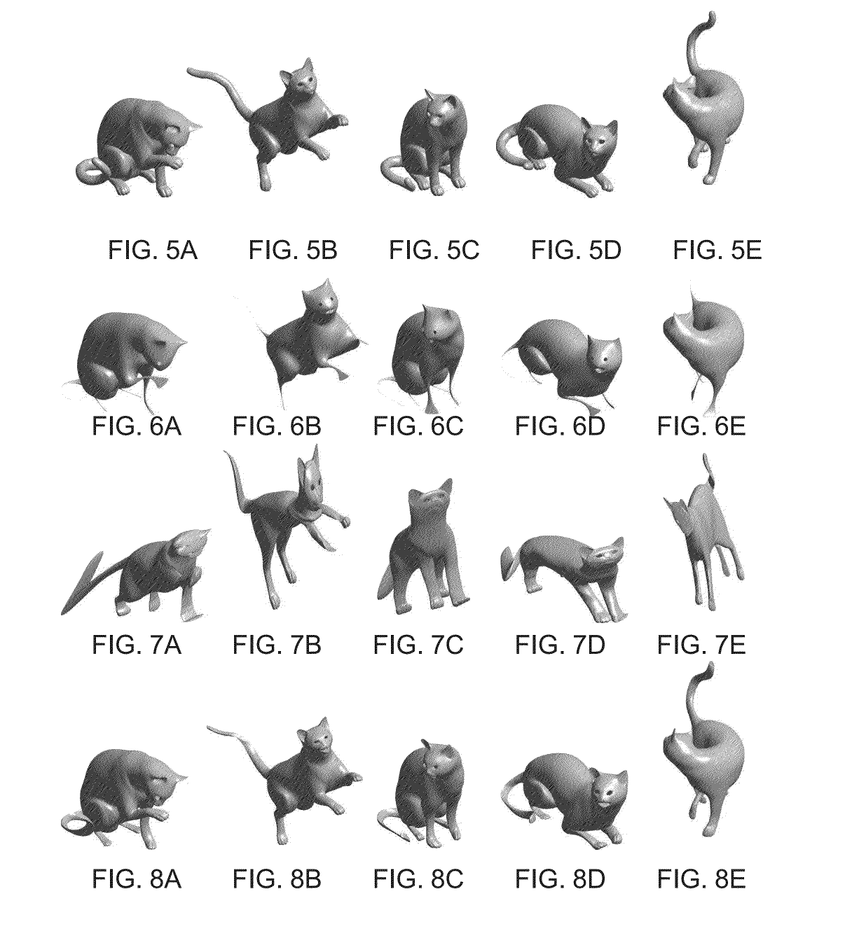

In a second experiment, different poses of a cat were considered. An orthonormal basis that minimizes the reconstruction error of the coordinates extracted from two poses was calculated according to some embodiments of the present invention. The two poses, shown in FIGS. 4A and 4B, provided six functions defined on the surface. These six functions were used as data vectors. Two sets of basis functions were constructed using the data vectors. A conventional PCA basis, and a set of basis functions constructed by calculating eigenvalues for an objective matrix M3 defined as AXX^{T}A+μ\tilde{W}⁻¹. The two sets were used to reconstruct five additional poses shown in FIGS. 5A-E which were approximately isometrics.

FIGS. 6A-E show the projections of the coordinates of the poses of FIGS. 5A-E to the first leading 100 vectors of the Laplace Beltrami eigen-basis, FIGS. 7A-E show the results of the reconstructions using the conventional PCA, and FIGS. 8A-E show the results of the reconstructions using the matrix M3. As shown, the results of the inventive technique are superior.

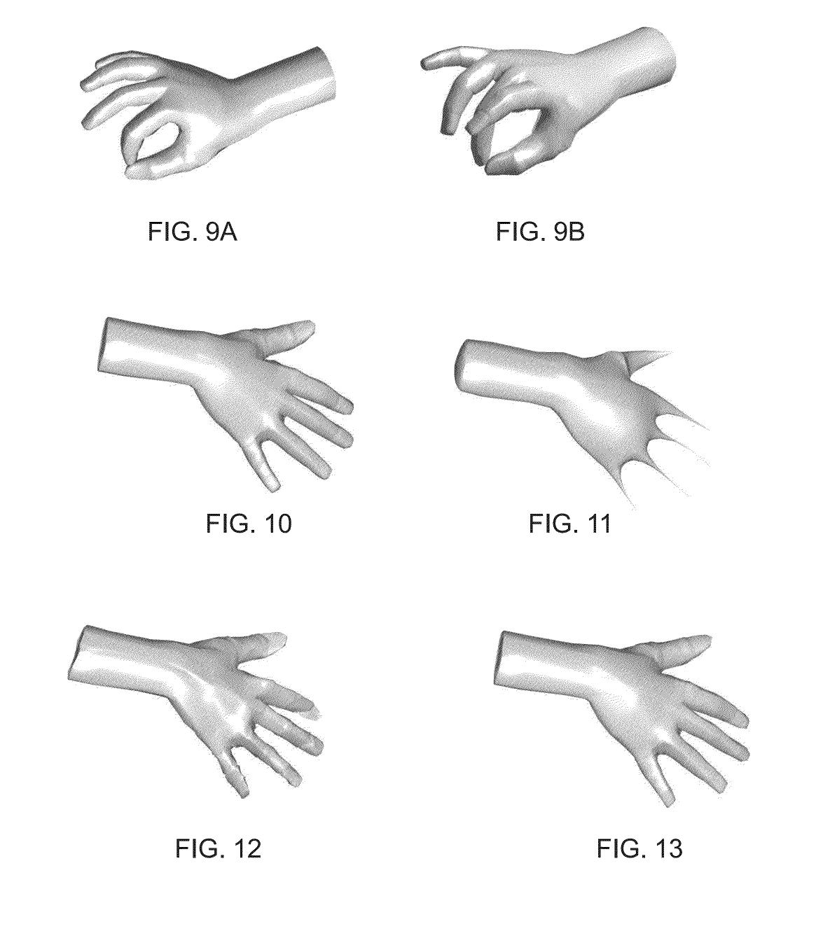

In a third experiment, a training set of 300 coordinate functions of 100 postures of a hand were used as data vector for reconstructing two sets of basis functions. A conventional PCA basis, and a set of basis functions constructed by calculating eigenvalues for an objective matrix M3 defined as AXX^{T}A+μ\tilde{W}⁻¹. In the present Example, μ was taken to be 0.5. Two hand postures of the training set are shown in FIGS. 9A and 9B.

The two sets were used to reconstruct an open hand postures shown in FIG. 10. FIG. 11 shows the result of the LBO reconstruction using all 300 functions, FIG. 12 shows the result of the reconstruction using the conventional PCA, and FIG. 13 shows the result of the reconstruction using the matrix M3. As shown, the result of the inventive technique is superior.

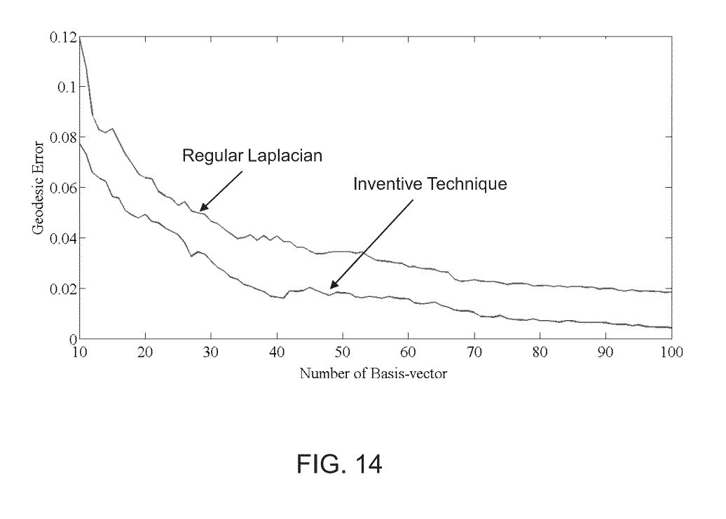

In a fourth experiment, functional map geodesic projection errors of the LBO basis were compared with a basis constructed according to some embodiments of the present invention using an objective matrix M3 defined as AXX^{T}A+μ\tilde{W}⁻¹ (μ=0.5, in the present example). Functional map geodesic projection error is a measure of mapping quality Ovsjanikov et al., Functional maps: a flexible representation of maps between shapes. ACM Trans. Graph., 31(4):30:1-30:11, 2012]. The eigen-bases were constructed using the Cartezian coordinates of the hand as data vectors. A few thousands delta functions were generated and projected onto the two bases. For each function the point with the highest value was selected. The accuracy of the mapping given by the geodesic distance between the selected point and its original, ground-truth location, where the delta function obtains a value of one, was calculated. The results are shown in FIG. 14. As shown, the inventive technique provides significantly better results compared to the LBO alone.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of constructing a set of basis functions, comprising:
receiving a set of data vectors describing a physical object or a physical phenomenon;
using a data processor for calculating a set of eigenvalues for an objective matrix defined as a sum of a first matrix corresponding to said set of data vectors and a second matrix corresponding to a Laplace-Beltrami operator, said objective matrix being a positive definite matrix; and
constructing the set of basis functions based on at least a subset of said eigenvalues.

2. The method of claim 1, wherein said calculating a set of eigenvalues is executed without storing said objective matrix.

3. A method of constructing a set of basis functions, comprising:
receiving a set of data vectors describing a physical object or a physical phenomenon;
using a data processor for calculating a set of eigenvalues for an objective matrix defined as a sum of a first matrix corresponding to said set of data vectors and a second matrix corresponding to a Laplace-Beltrami operator, said set of eigenvalues being calculated without storing said objective matrix; and
constructing the set of basis functions based on at least a subset of said eigenvalues.

4. The method of claim 1, wherein a sparsity of said second matrix is larger than a sparsity of said first matrix.

5. The method of claim 1, wherein said second matrix is a pseudo-inverse matrix of a weight matrix.

6. The method of claim 5, wherein said weight matrix is a cotangent weight matrix.

7. The method of claim 1, wherein said calculating said set of eigenvalues comprises executing an iterative procedure, which calculates, at each of at least some iterations, a processed vector without calculating said positive matrix, said processed vector being a multiplication of said positive matrix by one of said data vectors.

8. The method of claim 7, wherein said processed vector is calculated by applying to said data vector, separately, a first processing procedure corresponding said first matrix, and a second processing procedure corresponding said second matrix.

9. The method of claim 8, wherein said first processing procedure comprises multiplying said data vector by said first matrix.

10. The method of claim 8, wherein said second processing procedure comprises solving a vector equation so as to find a vector that, when multiplied by a weight matrix, provides said data vector.

11. The method of claim 1, wherein said data vectors describe at least one type of data selected from the group consisting of: coordinates of a physical surface or a computer generated surface, an image data, a signal, a temperature distribution, a light intensity distribution, a spectral distribution, a probability distribution, biological data, chemical data, and machine vision data.

12. A computer software product, comprising a non-volatile computer-readable medium in which program instructions are stored, which instructions, when read by a data processor, cause the data processor to execute the method of claim 1.

13. A system for constructing a set of basis functions, comprising a data processor configured for receiving a set of data vectors describing a physical object or a physical phenomenon, for calculating a set of eigenvalues for an objective matrix defined as a sum of a first matrix corresponding to said set of data vectors and a second matrix corresponding to a Laplace-Beltrami operator, said objective matrix being a positive definite matrix; and for constructing the set of basis functions based on at least a subset of said eigenvalues.

14. The system of claim 13, wherein said calculating said set of eigenvalues is executed without storing said objective matrix.

15. A system for constructing a set of basis functions, comprising a data processor configured for receiving a set of data vectors describing a physical object or a physical phenomenon, for calculating a set of eigenvalues for an objective matrix defined as a sum of a first matrix corresponding to said set of data vectors and a second matrix corresponding to a Laplace-Beltrami operator, said set of eigenvalues being calculated without storing said objective matrix; and for constructing the set of basis functions based on at least a subset of said eigenvalues.

16. The system of claim 13, wherein a sparsity of said second matrix is larger than a sparsity of said first matrix.

17. The system of claim 13, wherein said second matrix is a pseudo-inverse matrix of a weight matrix.

18. The system of claim 17, wherein said weight matrix is a cotangent weight matrix.

19. The system of claim 13, wherein said data processor is configured for calculating a set of eigenvalues by executing an iterative procedure, which calculates, at each of at least some iterations, a processed vector without calculating said positive matrix, said processed vector being a multiplication of said positive matrix by one of said data vectors.

20. The system of claim 19, wherein said data processor is configured for calculating said processed vector by applying to said data vector, separately, a first processing procedure corresponding said first matrix, and a second processing procedure corresponding said second matrix.

21. The system of claim 20, wherein said first processing procedure comprises multiplying said data vector by said first matrix.

22. The system of claim 20, wherein said second processing procedure comprises solving a vector equation so as to find a vector that, when multiplied by a weight matrix, provides said data vector.
